(19) United States
(12) Patent Application Publication
(10) Pub. No.: US 2006/0126159 A1
(43) Pub. Date: Jun. 15, 2006

(54) Parallel-structured Raman optical amplifier

(76) Inventors: Hee Sang Chung, Daejeon (KR); Sun Hyok Chang, Daejeon (KR); Won Kyoung Lee, Daejeon (KR); Kwang Joon Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/121,277

(22) Filed: May 2, 2005

(30) Foreign Application Priority Data
Dec. 10, 2004 (KR) 10-2004-104348

(51) Int. Cl. H01S 3/00

(52) U.S. Cl. 359/334

(57) ABSTRACT

A parallel-structured Raman optical amplifier includes a very wide gain band for use in Coarse Wavelength Division Multiplexing (CWDM) scheme—based optical transmission. The parallel-structured Raman optical amplifier for amplifying an input optical signal of a plurality of channels having different center wavelengths received via a single optical path includes: a demultiplexer for dividing the input optical signal into a plurality of optical signals, each of which is composed of at least one channel signal having an adjacent center wavelength, and outputting the divided optical signals to different output terminals; a plurality of Raman amplifiers for performing Raman-optical amplification upon the divided optical signals received from the demultiplexer; and a multiplexer for receiving individual optical signals from the plurality of Raman amplifiers, and outputting the received optical signals via a single optical path.

### RELATED APPLICATIONS

The present application is based on, and claims priority from, Korean Application Number 2004-104348, filed Dec. 10, 2004, the disclosure of which is incorporated by reference herein in its entirety.

### BACKGROUND OF THE INVENTION

1. Field of the Invention

The present invention relates to an optical amplifier for use in optical communication, and more particularly to a parallel-structured Raman optical amplifier including a very wide gain band for use in Coarse Wavelength Division Multiplexing (CWDM) scheme—based optical transmission.

2. Description of the Related Art

Wavelength Division Multiplexing (WDM) technologies are indicative of excellent optical transmission technologies for increasing a transmission capacity by transmitting light (i.e., an optical or light signal) having different wavelengths via a single transmission path. The WDM technologies are classified into a Dense WDM (DWDM) scheme for use with light having a wavelength spacing of about 0.8˜3.2 nm, and a Coarse WDM (CWDM) scheme for use with light having a wavelength spacing of about 20 nm.

The above-mentioned CWDM scheme has a very wide interval among individual channels, such that it has fewer requirements associated with wavelength stabilization varying with temperature than those of the above-mentioned DWDM scheme. Therefore, the above-mentioned CWDM scheme is superior to the DWDM scheme in a variety of aspects, for example, size, power consumption, and costs, etc., such that it has been widely used for metro-optical transmission.

The CWDM-based transmission system has different maximum transmission distances according to the number of used channels, but it should be noted that the maximum transmission distances are not higher than a predetermined distance of 100 km although a single channel is used. The higher the number of channels, the higher the loss of optical components for use in multiplexing/demultiplexing processes. Therefore, if an optical amplifier capable of compensating for an additional loss is not used, the transmission distance is further reduced.

Other problem capable of limiting the transmission distance other than the above-mentioned optical signal loss problem is indicative of a dispersion-based problem. If a laser is directly modulated in the case of a bit rate of 2.5 Gbit/s per channel, transmission of 100 km is available whereas the other transmission of 200 km is not available. Therefore, both the optical signal loss and the dispersion must be compensated to perform the above-mentioned transmission of 200 km. Transmission characteristic deterioration caused by the dispersion is worsened in the case of a bit rate of 10 Gbit/s per channel, such that it is well known in the art that transmission of about 20 km is not available without using an additional dispersion compensator. In order to increase a transmission distance of the CWDM-based optical transmission system, both loss and dispersion of a signal must be compensated.

A variety of conventional optical amplifiers for use in the above-mentioned CWDM-based optical transmission system have been proposed to compensate for the loss of channel. A detailed description of technologies associated with the aforementioned conventional optical amplifiers will hereinafter be described.

First, an Erbium-Doped Fiber Amplifier (EDFA) is used in the case of a small number of channels. The EDFA can amplify signals of 5 channels, i.e., a first channel of 1530 nm, a second channel of 1550 nm, a third channel of 1570 nm, a fourth channel of 1590 nm, and a fifth channel of 1610 nm. In order to amplify the signals of 5 channels using the EDFA, a C-band EDFA and an L-band EDFA must be connected in parallel or in series. Other EDFA utilization technology may also use 5 independent EDFAs capable of amplifying output signals of individual channels, respectively. However, if the number of channels is increased, a shorter wavelength including 1510 nm is added, such that amplification is not available.

Secondly, a Linear Optical Amplifier (LOA) acting as a semiconductor optical amplifier having a fixed gain may be used in the case of a small number of channels. A representative application example of the above-mentioned LOA has been proposed by H. Thiele et al., who have published a research paper entitled “Linear Optical Amplifier For Extended Reach in CWDM Transmission” in OFC 2003, vol. 1, pp. 23˜34, which is incorporated herein by reference. According to the above-mentioned representative application example, the LOA transmits a total of 16-channel signals of 1310 nm, 1330 nm, . . . , 1610 nm by a predetermined distance of 75 km, and four-channel signals of 1510 nm, 1530 nm, 1550 nm, and 1570 nm from among the above-mentioned 16-channel signals are separately amplified using the LOA such that the above four-channel signals of 1510 nm, 1530 nm, 1550 nm, and 1570 nm are transmitted by a predetermined distance of 135 km. In more detail, the LOA is unable to perform an amplification operation in a wavelength band other than the above-mentioned four-channel signals, and a transmission distance, such that a transmission distance is extended in association with only some amplifiable channels. However, the author of the above-mentioned reference document has insisted that the LOA can theoretically perform an amplification operation even in the case of using other wavelengths, such that the author has proposed that an improved LOA capable of performing the amplification operation using other wavelength bands of the CWDM system must be designed and used. In other words, if a single LOA is designed to amplify about 4-channel signals, 16-channel signals are distributed to 4-wavelength bands, are amplified using LOAs suitable for individual 4-wavelength bands, and are multiplexed, such that the above-mentioned 16-channel signals can be amplified. However, the LOA capable of performing the amplification operation in other wavelengths other than 1510 nm-1570 nm has been theoretically proposed by the author of the above-mentioned reference document, indeed, it has not been implemented yet.

Thirdly, a method for using a semiconductor quantum-dot optical amplifier has recently been proposed. A representative application example of the above-mentioned semiconductor quantum-dot optical amplifier has been proposed by T. Akiyama et al., who have published a research paper entitled “An Ultrawide-band (120 nm) Semiconductor Optical Amplifier Having an Extremely-high Penalty-free Output Power of 23 dBm Realized with Quantum-dot Active Layers” in OFC 2004, PDP 12, which is incorporated herein by reference. According to the above-mentioned representative application example, it can be recognized that a wavelength band capable of obtaining a gain of more than 20 dB using a single semiconductor quantum-dot optical amplifier is extended to 120 nm. In more detail, signals of about 7 CWDM channels can be amplified using only one optical amplifier. However, the above-mentioned semiconductor quantum-dot optical amplifier has a disadvantage in that it has different gains according to signal polarization. In other words, the semiconductor quantum-dot optical amplifier has different output levels according to polarization states of an input signal, such that it cannot guarantee transmission performance.

Fourthly, a method for amplifying 8-channel signals of the CWDM system by combining a first optical amplifier capable of amplifying an S-band with a conventional EDFA in parallel to each other has been proposed by M. Yamada entitled “Recent Progress on Ultra-wide Band Optical Amplifiers” in OECC 2004, pp. 498, which is incorporated herein by reference. The above-mentioned method can be implemented using the following first and second schemes. The first scheme separates 8 channels from each other using a demultiplexing method, amplifies signals of individual 8 channels, and combines them using a multiplexing method. The first scheme uses a total of 8 amplifiers. In more detail, signals of 1470 nm, 1490 nm, and 1510 nm use three Thulium Doped Fiber Amplifiers (TDFAs) acting as the S-band optical amplifier, signals of 1530 nm, 1550 nm, and 1570 nm use three C-band EDFAs, and signals of 1590 nm and 1610 nm use two L-band EDFAs. The second scheme divides 8-channel signals into 4-channel signals of 1470 nm˜1530 nm and other 4-channel signals of 1550 nm˜1610 nm, amplifies the divided channel signals, and combines them with each other. The second scheme uses a TDFA and an EDFA connected in series in the case of a short wavelength, and uses an L-band Tellurite EDFA in the case of a long wavelength. According to the above-mentioned second scheme, a Thulium-Doped Fiber indicative of the most important component of the TDFA must perform vacuum packaging not to absorb moisture, such that the optical amplifier has low reliability.

Fifth, a method for manufacturing a highly Non-Linear Fiber (HNLF) having a Raman gain coefficient, which is at least doubled the other Raman gain coefficient of a Dispersion-Compensating Fiber (DCF), and adapting the HNLF as a gain medium of a Raman optical amplification has been proposed by T. Miyamoto et al., entitled “Highly-Nonlinear-Fiber-Based Discrete Raman Amplifier for CWDM Transmission systems” in OFC 2003, vol. 1, pp. 20, which is incorporated herein by reference. In this case, the above-mentioned method obtains a gain of more than 10 dB from 8 channels of the CWDM system using a Raman pump having a total of 6 wavelengths (the sum of optical power=1,110 mW). The Raman pump includes six wavelengths of 1360 nm, 1390 nm, 1405 nm, 1430 nm, 1460 nm, and 1500 nm. In this case, the wavelength of 1460 nm is adjacent to a signal wavelength of 1470 nm acting as a signal wavelength, and the signal wavelength of 1500 nm is adjacent to signal wavelengths of 1490 nm and 1510 nm, such that unexpected crosstalk occurs when the signal wavelengths vary with temperature and overlap with a pump wavelength.

As stated above, the above-mentioned conventional optical amplifiers for use in a CWDM-based optical transmission system cannot guarantee stability of an optical amplifier, and cannot guarantee transmission performance of the optical amplifier due to polarization dependency. Further, the above-mentioned conventional optical amplifiers encounter unexpected crosstalk due to the overlapping between the signal wavelength and the pump wavelength.

Particularly, the conventional optical amplifiers cannot provide improved technologies capable of amplifying a maximum of 16 channels (Center wavelengths of individual channels=1310 nm, 1330 nm, 1350 nm, . . . , and 1610 nm) to be substantially used in a CWDM optical transmission system.

### SUMMARY OF THE INVENTION

Therefore, the present invention has been made in view of the above problems, and it is an object of the present invention to provide a parallel-structured Raman optical amplifier which can guarantee system stability and transmission performance, can prevent unexpected crosstalk from being generated due to the overlapping between a signal wavelength and a pump wavelength, and can amplify a broadband optical signal for use in a CWDM optical transmission system.

In accordance with the present invention, the above and other objects can be accomplished by the provision of a parallel-structured Raman optical amplifier apparatus for amplifying an input optical signal of a plurality of channels having different center wavelengths received via a single optical path, comprising: a demultiplexer for dividing the input optical signal into a plurality of optical signals, each of which is composed of at least one channel signal having an adjacent center wavelength, and outputting the divided optical signals to different output terminals; a plurality of Raman amplifiers for performing Raman-optical amplification upon the divided optical signals received from the demultiplexer; and a multiplexer for receiving individual optical signals from the plurality of Raman amplifiers, and outputting the received optical signals via a single optical path.

Preferably, each of the Raman amplifiers includes: an optical fiber for applying a Raman gain to an optical signal divided by the demultiplexer; a pump unit for applying a Raman gain to the optical fiber; and a wavelength division connector for applying a pumping optical signal generated from the pump unit to the optical fiber.

The parallel-structured Raman optical amplifier apparatus further comprises: a first isolator for preventing a signal applied to the demultiplexer from being reflected; and a second isolator for preventing an output signal of the multiplexer from being reflected.

In accordance with a preferred embodiment of the present invention, in order to prevent the problem of overlapping between an amplified optical signal wavelength and a pumping optical signal wavelength from being generated, the demultiplexer divides the input optical signal into a plurality of optical signals each composed of 1 to 4 channels having adjacent center wavelengths. In this case, the pumping optical signal generated from the pump unit may be indicative of a plurality of pumping optical signals having a maximum of 4 different wavelengths.

In order to remove a polarization dependency of the pumping optical signals according to one aspect of the present invention, the pump unit includes: at least one Laser Diode (LD) for generating a pumping optical signal; and a depolarizer positioned between the LD and the wavelength division connector. In order to remove the above-mentioned polarization dependency according to another aspect of the present invention, the pump unit includes: at least one LD unit composed of two LDs which generate pumping optical signals having the same wavelength; a polarization controller for controlling individual polarizations of pumping optical signals generated from the LDs contained in the LD unit to be perpendicular to each other; and a polarization beam combiner for combining two optical signals which are controlled to be perpendicular to each other in the polarization controller.

Preferably, the optical fiber may be indicative of a silica-based optical fiber which has very low loss and high stability. Particularly, the optical fiber may be indicative of a Dispersion-Compensating Fiber (DCF) capable of compensating for dispersion accumulated in an optical path from among a variety of silica-based optical fibers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a structural diagram illustrating a parallel-structured Raman optical amplifier in accordance with a preferred embodiment of the present invention;

FIG. 2 is a graph illustrating the relationship between the number of pumping optical signals and gain/noise characteristics in a parallel-structured Raman optical amplifier in accordance with a preferred embodiment of the present invention; and

FIG. 3 is a structural diagram illustrating a parallel-structured Raman optical amplifier in accordance with another preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

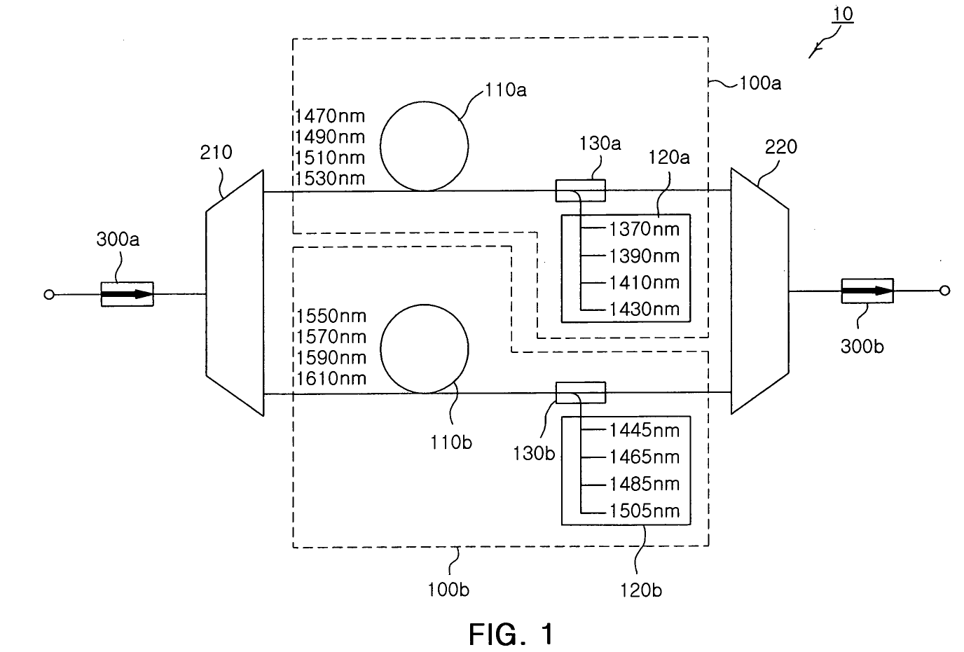

FIG. 1 is a structural diagram illustrating a parallel-structured Raman optical amplifier in accordance with a preferred embodiment of the present invention. FIG. 1 shows a parallel-structured Raman optical amplifier for dividing 8-channel optical signals into four channels having adjacent center wavelengths when the 8-channel optical signals having different center wavelengths are transmitted via a single optical path. Particularly, the above-mentioned 8-channel optical signals are indicative of 8-channel optical signals based on the ITU-T Recommendation G.695 Standard. In this case, center wavelengths of individual channels are determined to be 1470 nm, 1490 nm, 1510 nm, . . . , 1610 nm at 25° C. It is assumed that center wavelengths of the following channels are each determined to be a center wavelength at 25° C.

Referring to FIG. 1, the parallel-structured Raman optical amplifier 10 according to the present invention includes a demultiplexer 210 for dividing an input optical signal into two optical signals, each of which is composed of 4-channel signals having adjacent center wavelengths, and outputting the divided optical signals to two different output terminals; two Raman amplifiers 100a and 100b for performing Raman-optical amplification of the divided optical signals received from the demultiplexer 210; and a multiplexer 220 for receiving individual optical signals from the two Raman amplifiers 100a and 100b, and outputting the received optical signals via a single optical path.

In accordance with a preferred embodiment of the present invention, the parallel-structured Raman optical amplifier 10 further includes a first isolator 300a mounted to a front end of the demultiplexer 210 to prevent a signal applied to the demultiplexer 210 from being reflected; and a second isolator 300b mounted to a rear end of the multiplexer 220 to prevent an output signal of the multiplexer 220 from being reflected.

The demultiplexer 210 receives an optical signal of a plurality of channels via a single optical path, and divides the received optical signal into two optical signals each composed of 4 channels having adjacent center wavelengths according to center wavelengths of individual channels. The input optical signal includes 8 channels. The demultiplexer 210 divides the input optical signal into a first optical signal including 4 channels having center wavelengths of 1470 nm, 1490 nm, 1510 nm, and 1530 nm, respectively, and a second optical signal including 4 channels having center wavelengths of 1550 nm, 1570 nm, 1590 nm, and 1610 nm, respectively, such that the first and second optical signals are transmitted to two different output terminals, respectively. Preferably, the optical signal transmitted to one output terminal of the demultiplexer 210 may include a maximum of 4 channels. If the optical signal transmitted to the one output terminal of the demultiplexer 210 is comprised of more than 5 channels, a band to be amplified by the Raman amplifiers 100a and 100b is increased, and the number of pumping optical signals must also be increased due to the increased band, such that a signal wavelength may overlap with a pumping optical signal wavelength in the same manner as in the conventional reference document proposed by Miyamoto.

The Raman amplifiers 100a and 100b amplify individual optical signals divided by the demultiplexer 210. The Raman amplifier 100a will be referred to as a first Raman amplifier 100a, and the other Raman amplifier 100b will be referred to as a second Raman amplifier 100b. The first and second Raman amplifiers 100a and 100b include appropriate bandwidths capable of amplifying an optical signal of a channel received in a corresponding Raman amplifier, because the Raman amplifiers properly adjust wavelengths of pumping optical signals generated from pump units 120a and 120b which transmit pumping optical signals to optical fibers used as gain mediums in the Raman amplifiers.

The first Raman amplifier 100a includes an optical fiber 110a for applying a Raman gain to an optical signal divided by the demultiplexer 210; a pump unit 120a for applying a Raman gain to the optical fiber 110a; and a wavelength division connector 130a for applying a pumping optical signal generated from the pump unit 120a to the optical fiber 110a. The second Raman amplifier 100b includes an optical fiber 110b for applying a Raman gain to an optical signal divided by the demultiplexer 210; a pump unit 120b for applying a Raman gain to the optical fiber 110b; and a wavelength division connector 130b for applying a pumping optical signal generated from the pump unit 120b to the optical fiber 110b.

The optical fibers 110a and 110b are indicative of gain mediums for transmitting a gain to a corresponding channel optical signal. It is preferable for a silica-based optical fiber having high stability and low loss to be used. Particularly, the optical fibers 110a and 110b are each made of DCF. If the DCF is used as the above-mentioned gain medium, a gain can be supplied to the optical signal, and at the same time dispersion accumulated by an optical path can be compensated.

The pump unit 120a transmits one or more pumping optical signals having appropriate wavelengths and power, using which an optical signal of the Raman amplifier 100a can obtain a Raman gain, to the optical fiber 110a. In this way, the pump unit 120b transmits one or more pumping optical signals having appropriate wavelengths and power, using which an optical signal of the Raman amplifier 100a can obtain a Raman gain, to the optical fiber 110b. According to a preferred embodiment of the present invention, a pumping optical signal having four different wavelengths is applied to individual Raman amplifiers 100a and 100b. A pumping optical signal having center wavelengths of 1370 nm, 1390 nm, 1410 nm, and 1430 nm is transmitted to the first Raman amplifier 100a. A pumping optical signal having center wavelengths of 1445 nm, 1465 nm, 1485 nm, and 1505 nm is transmitted to the second Raman amplifier 100b. The present invention can properly determine the number of optical signal channels (preferably, a maximum of 4 optical signal channels) amplified by a single Raman amplifier, such that a wavelength of a pumping optical signal can be properly determined not to overlap with an optical signal wavelength. Therefore, the present invention can prevent crosstalk from being generated in the Raman optical amplification process due to the overlapping between the optical signal wavelength and the pumping optical wavelength.

The pump units 120a and 120b include a laser diode (LD) for generating a pumping optical signal having a desired wavelength. The number of LDs may be changed with the number of pumping optical signals received from the pump units 120a and 120b. In order to remove polarization dependency of the pumping optical signals received from the pumping units 120a and 120b, each of the pump units 120a and 120b may further include at least one LD for generating a pumping optical signal and a depolarizer positioned between the LD and the wavelength division connector 130a or 130b. According to the other method for removing the polarization dependency, the present invention may perform a polarization multiplexing operation of two pumping optical signals having perpendicular polarizations, instead of using the above-mentioned depolarizer, such that it may use the polarization-multiplexed pumping optical signals. In this case, the pump units 120a and 120b each include an LD unit composed of two LDs which generate pumping optical signals having the same wavelength to generate a single pumping optical signal; a polarization controller for controlling polarization of optical signals generated from the LDs contained in the LD unit; and a polarization beam combiner for combining two optical signals which are controlled to be perpendicular to each other in the polarization controller. The same pump power is applied to two polarization states perpendicular to each other, such that polarization dependency can be removed from an amplification process.

The Wavelength Division Multiplexers (WDMs) 130a and 130b apply the pumping optical signal generated from the pump units 120a and 120b to the optical fibers 110a and 110b. Although FIG. 1 shows a backward Raman pump structure in which the pumping optical signal is applied from the rear ends of the optical fibers 110a and 110b in a reverse direction of the optical signal, it should be noted that the present invention is not limited to the above-mentioned exemplary structure of FIG. 1. In accordance with another preferred embodiment of the present invention, the present invention may use a forward Raman pump structure in which a pumping optical signal is applied from the front ends of the optical fibers 110a and 110b in a forward direction of the optical signal, and may also use a bi-directional Raman pump structure in which the backward Raman pump structure and the forward Raman pump structure are combined. It should be noted that the backward Raman pump structure has a good output characteristic superior to that of the forward Raman pump structure whereas it has a deteriorated noise figure characteristic compared with the forward Raman pump structure. A specific phenomenon in which Relative Intensity Noise (RIN) of a pump is transmitted to a signal occurs in the forward Raman pump structure. The above-mentioned specific phenomenon deteriorates signal performance when the RIN of the pump is accumulated after passing through a plurality of optical amplifiers. However, the backward Raman pump structure has an advantage in that it minimizes RIN transmission and reduces polarization dependency.

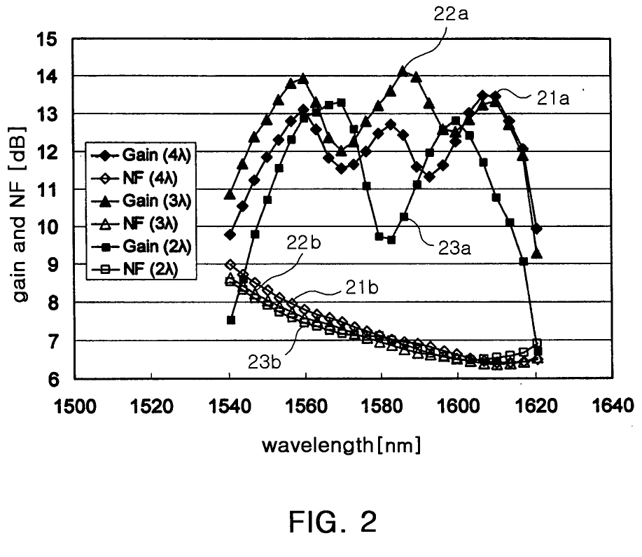

As stated above, the pump units 120a and 120b can transmit one or more pumping optical signals having different center wavelengths to optical fibers. For example, the present invention provides an example in which four pumping optical signals are applied to each Raman amplifier. The higher the number of pumping optical signals, the higher the costs of an amplifier. Therefore, it is preferable that pumping optical signals are properly used according to a wavelength of an optical signal having a gain to be obtained. In order to determine the proper number of pumping optical signals, the inventor of the present invention has conducted the following experiment shown in FIG. 2 and the following Table 1.

FIG. 2 is a graph illustrating gain and noise figure characteristics when a different number of pumping optical signals are transmitted to a DCF having a length of 14 km. The following table 1 shows wavelengths and output powers of pumping optical signals for use in the experiment shown in FIG. 2 and gain bands and gain deviations of individual wavelengths.

TABLE 1

| | |
|---|---|
| Pump Wavelength | Gain Band (Gain |
| (Output power) | Deviation) |

| | | | | |
|---|---|---|---|---|
| 4 pumping optical | 1450 nm | (350 mW), | 75 nm | (2.1 dB) |
| signals | 1470 nm | (150 mW), | | |
| | 1480 nm | (40 mW), | | |
| | 1510 nm | (70 mW) | | |
| 3 pumping optical | 1450 nm | (400 mW), | 72 nm | (2.1 dB) |
| signals | 1477 nm | (140 mW), | | |
| | 1505 nm | (80 mW) | | |
| 2 pumping optical | 1460 nm | (400 mW), | 68 nm | (3.7 dB) |
| signals | 1500 nm | (150 mW) | | |

Referring to FIG. 2, and Table 1, if 4 pumping optical signals are used as denoted by 21a and 21b, a gain band of 75 nm and a gain deviation of 2.1 dB are generated. If 3 pumping optical signals are used as denoted by 22a and 22b, a gain band of 72 nm and a gain deviation of 2.1 dB are generated. If 2 pumping optical signals are used, a gain band of 68 nm and a gain deviation of 3.7 dB are generated. If the number of pumping optical signals is changed to another number, there is little difference in noise figure characteristics of the above-mentioned three cases. As can be seen from the above description, a relatively high gain deviation occurs between the case in which 2 pumping optical signals are used and the other case in which 3 pumping optical signals are used, and a relatively low gain deviation occurs between the case in which 3 pumping optical signals are used and the other case in which 4 pumping optical signals are used. Therefore, it can be recognized that the case of using 3 pumping optical signals is the best case in consideration of performance and cost aspects of the Raman optical amplifier. The above-mentioned experimental result intends to explain the fact that the number of pumping optical signals and their wavelengths can be properly adjusted. If a gain band of the Raman optical amplifier or the number of requirements associated with a gain deviation is reduced, one or two pumping optical signals may be used in the present invention.

Referring back to FIG. 1, the multiplexer 220 receives individual amplified optical signals from two Raman amplifiers 100a and 100b, and outputs the received optical signals via a single optical path. In accordance with a preferred embodiment of the present invention, the multiplexer 220 multiplexes two optical signals each composed of four channels into a single optical signal composed of 8 channels, and outputs the single optical signal composed of 8 channels via a single optical path.

The first and second isolators 300a and 300b allow the optical signal to run along only a desired direction, such that optical signals reflected in the reverse direction are blocked. The first isolator 300a is positioned at the front end of the demultiplexer 210, and allows an optical signal to pass the demultiplexer 210 at a very low loss of less than 0.5 dB. However, the first isolator 300a allows a signal traveling along the opposite direction to the above-mentioned signal path to be largely suppressed, such that the reverse signal is unable to pass through the isolator. The above-mentioned signal traveling along the above-mentioned opposite direction may deteriorate performance of an optical amplifier due to single-sided reflection or optical component reflection. Similarly, the second isolator 300b is positioned at the rear end of the multiplexer 220, passes an output signal of the multiplexer 220, and blocks a signal traveling along the opposite direction to the output signal of the multiplexer 220.

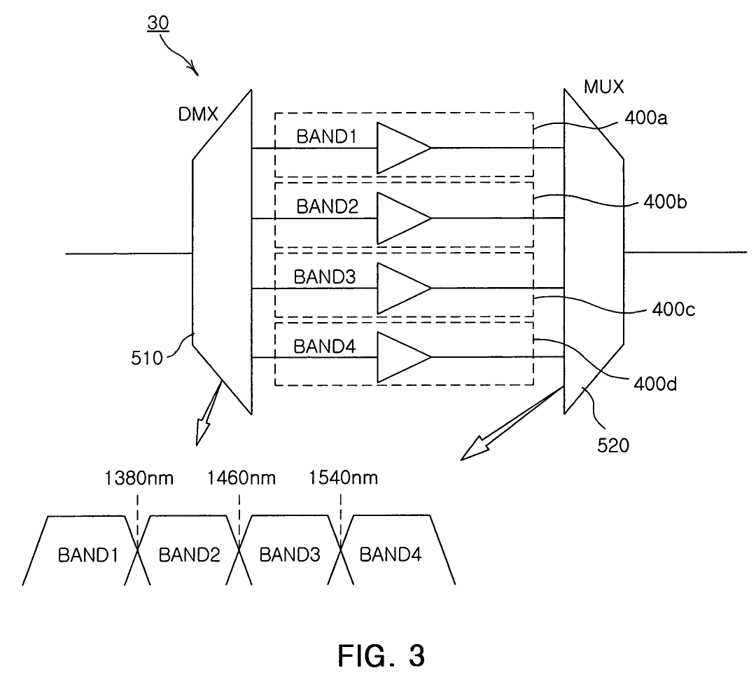

The above-mentioned preferred embodiment of FIG. 1 divides an optical signal composed of 8 channels having different center wavelengths of 1470 nm, 1490 nm, . . . , 1610 nm into two optical signal bands each composed of 4 channels having different center wavelengths, and amplifies the divided optical signals. It should be noted that the Raman optical amplification structures of the present invention are not limited to the number of channels contained in the optical signal. FIG. 3 shows another example in which the parallel-structured Raman optical amplifier of FIG. 1 is applied to an optical amplifier having a total of 16 channels in accordance with another preferred embodiment of the present invention.

As can be seen from FIG. 3, the Raman optical amplifier according to another preferred embodiment of the present invention is indicative of a Raman optical amplifier capable of amplifying an input optical signal composed of 16 channels having different center wavelengths received via a single optical path. The above-mentioned input optical signal composed of 16 channels may be indicative of an optical signal composed of a plurality of channels having different center wavelengths of 1310 nm, 1330 nm, 1350 nm, . . . , 1610 nm. In this case, it is expected that the above-mentioned optical signal will be maximally used in a CWDM system according to the ITU-T Recommendation. The parallel-structured Raman optical amplifier 30 according to another preferred embodiment of the present invention includes a demultiplexer 510 for dividing an input optical signal into four optical signals, each of which is composed of 4-channel signals having adjacent center wavelengths, and outputting the divided optical signals to four different output terminals; four Raman amplifiers 400a-400d connected to output terminals of the demultiplexer 510 such that they perform Raman-optical amplification of the four divided optical signals; and a multiplexer 520 for receiving individual amplified optical signals from the Raman amplifiers 400a˜400d, and outputting the received optical signals via a single optical path.

Provided that the input optical signal is indicative of an optical signal composed of 16 channels according to the ITU-T Recommendation, the demultiplexer 510 divides the input optical signal into a first optical signal, a second optical signal, a third optical signal, and a fourth optical signal. In this case, the first optical signal includes four channels having center wavelengths of 1310 nm, 1330 nm, 1350 nm, and 1370 nm. The second optical signal includes four channels having center wavelengths of 1390 nm, 1410 nm, 1430 nm, and 1450 nm. The third optical signal includes four channels having center wavelengths of 1470 nm, 1490 nm, 1510 nm, and 1530 nm. The fourth optical signal includes four channels having center wavelengths of 1550 nm, 1570 nm, 1590 nm, and 1610 nm.

Individual optical signals divided into four wavelength bands by the demultiplexer 510 are Raman-amplified by the Raman amplifiers 400a˜400d.

The Raman amplifiers 400a˜400d each include an optical fiber for generating a Raman gain; a pump unit for generating at least one pumping optical signal to generate a Raman gain in the optical fiber; and a wavelength division connector for applying a pumping optical signal generated from the pump unit to the optical fiber, as previously described in FIG. 1. Preferably, the optical fiber is indicative of a DCF capable of compensating for accumulated dispersion of an optical path. The pump unit transmits one to four pumping optical signals having proper wavelengths to a wavelength band to be amplified by the Raman amplifiers 400a˜400d. One optical signal separated by the demultiplexer 510 includes a maximum of four channels such that the problem of overlapping between a wavelength of a pumping optical signal generated from the pump unit and a wavelength of an optical signal to be divided and amplified by the demultiplexer 510 can be solved. The pumping optical signal generated from the pump unit is limited to a pumping optical signal having a maximum of 4 different wavelengths. A more detailed description of the above-mentioned Raman amplifiers 400a and 400b is equal to those of FIG. 1, so that its detailed description will herein be omitted for the convenience of description.

Four optical signals amplified according to individual wavelength bands by the Raman amplifiers 400a and 400b are combined by the multiplexer 520, such that they are outputted via a single optical path in the same manner as in the above-mentioned signal input case.

As described above, the parallel-structured Raman optical amplifier according to the present invention divides an optical signal composed of a plurality of channels into optical signals each composed of a maximum of 4 channels, Raman-amplifies the divided optical signals, and multiplexes the Raman-amplified result, such that there is no need for a plurality of broadband channel optical signals to be amplified at one time. In other words, the parallel-structured Raman optical amplifier can amplify an optical signal composed of a maximum of 16 channels to be used according to the ITU-T Recommendation throughout the entire band. Particularly, the parallel-structured Raman optical amplifier efficiently removes the problem of overlapping between a pumping optical signal wavelength and an optical signal wavelength in the Raman optical amplification process as compared to the other Raman optical amplification method capable of amplifying a broadband signal at one time, such that it prevents crosstalk from being generated.

Also, the parallel-structured Raman optical amplifier according to the present invention uses a silica-based optical fiber as a gain medium for use in optical amplification, such that it has very low loss and high stability. Particularly, the parallel-structured Raman optical amplifier uses a DCF from among a variety of silica-based optical fibers, such that it provides an optical fiber with a gain and at the same time compensates for dispersion accumulated in an optical path.

As apparent from the above description, the parallel-structured Raman optical amplifier according to the present invention divides an optical signal composed of a plurality of channels into optical signals each composed of a maximum of 4 channels, Raman-amplifies the divided optical signals, and multiplexes the Raman-amplified result, such that a plurality of broadband optical signals can be amplified. In other words, the parallel-structured Raman optical amplifier can amplify an optical signal composed of a maximum of 16 channels to be used according to the ITU-T Recommendation throughout the entire band.

Further, the parallel-structured Raman optical amplifier efficiently removes the problem of overlapping between a pumping optical signal wavelength and an optical signal wavelength in the Raman optical amplification process as compared to a conventional Raman optical amplification method capable of amplifying a broadband signal at one time, such that it prevents crosstalk from being generated.

Also, the parallel-structured Raman optical amplifier according to the present invention uses a silica-based optical fiber as a gain medium for use in optical amplification, such that it has very low loss and high stability. Particularly, the parallel-structured Raman optical amplifier uses a DCF from among a variety of silica-based optical fibers, such that it provides an optical fiber with a gain and at the same time compensates for dispersion accumulated in an optical path.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A parallel-structured Raman optical amplifier apparatus for amplifying an input optical signal of a plurality of channels having different center wavelengths received via a single optical path, comprising:
a demultiplexer for dividing the input optical signal into a plurality of optical signals, each of which is composed of at least one channel signal having an adjacent center wavelength, and outputting the divided optical signals to different output terminals;
a plurality of Raman amplifiers for performing Raman-optical amplification upon the divided optical signals received from the demultiplexer, wherein each of the Raman amplifiers generates at least one pumping optical signal each having a different center wavelength; and
a multiplexer for receiving individual optical signals from the plurality of Raman amplifiers, and outputting the received optical signals via a single optical path.

2. The apparatus according to claim 1, wherein each of the Raman amplifiers includes:
an optical fiber for applying a Raman gain to an optical signal divided by the demultiplexer;
a pump unit for applying a Raman gain to the optical fiber; and
a wavelength division connector for applying the pumping optical signal generated from the pump unit to the optical fiber.

3. The apparatus according to claim 1, further comprising:
a first isolator for preventing a signal applied to the demultiplexer from being reflected; and
a second isolator for preventing an output signal of the multiplexer from being reflected.

4. The apparatus according to any one of claims 1 and 2, wherein the demultiplexer divides the input optical signal into a plurality of optical signals each composed of 1 to 4 channels having adjacent center wavelengths.

5. The apparatus according to claim 4, wherein the pump unit generates first to fourth pumping optical signals having different wavelengths.

6. The apparatus according to claim 2, wherein the optical fiber is indicative of a silica-based optical fiber.

7. The apparatus according to any one of claims 2 and 6, wherein the optical fiber is indicative of a Dispersion-Compensating Fiber (DCF).

8. The apparatus according to claim 2, wherein the pump unit includes:
at least one Laser Diode (LD) for generating a pumping optical signal; and
a depolarizer positioned between the LD and the wavelength division connector.

9. The apparatus according to claim 2, wherein the pump unit includes:
at least one LD unit composed of two .LDs which generate pumping optical signals having the same wavelength;
a polarization controller for controlling individual polarizations of pumping optical signals generated from the LDs contained in the LD unit to be perpendicular to each other; and
a polarization beam combiner for combining two optical signals which are controlled to be perpendicular to each other in the polarization controller.

10. A parallel-structured Raman optical amplifier apparatus for amplifying an input optical signal of 16 channels having different center wavelengths received via a single optical path, comprising:
a demultiplexer for dividing the input optical signal into four optical signals, each of which is composed of four channel signals having adjacent center wavelengths, and outputting the divided optical signals to four output terminals;
four Raman amplifiers connected to the four output terminals of the demultiplexer, respectively, for performing Raman-optical amplification of the four divided optical signals; and
a multiplexer for receiving individual optical signals amplified by the Raman amplifiers, and outputting the received optical signals via a single optical path, wherein each of the Raman amplifiers includes:
an optical fiber for applying a Raman gain to an optical signal divided by the demultiplexer;
a pump unit for applying a Raman gain to the optical fiber, the pump unit transmits at least one pumping optical signal each having a different center wavelength; and
a wavelength division connector for applying the pumping optical signal generated from the pump unit to the optical fiber.
